(19) United States
(12) Patent Application Publication
(10) Pub. No.: US 2009/0196546 A1
(43) Pub. Date: Aug. 6, 2009

(54) Optical Integrated Circuit, Opto-Electronic Integrated Circuit and Manufacturing Method Thereof

(75) Inventor: Tomiyuki ARAKAWA, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/354,829

(22) Filed: Jan. 16, 2009

(30) Foreign Application Priority Data
Feb. 4, 2008 (JP) 2008-023918

(51) Int. Cl. G02B 6/12

(52) U.S. Cl. 385/14

(57) ABSTRACT

In the opto-electronic integrated circuit, an optical waveguide in which a sapphire substrate for an SOS substrate is formed as a lower clad and a silicon film is formed as a core, an electronic integrated circuit formed in the silicon film, and grooves for fixing optical fibers are formed monolithically. Further, a photodiode array and a laser diode array are mounted on a hybrid basis. Since the lower clad of the optical waveguide is used as the sapphire substrate and the core is used as the silicon film, a difference in refractive index can be made large sufficiently, thus resulting in thinning of the silicon film. It is therefore possible to shorten the time required to process the core and the like. Further, since the electronic integrated circuit is formed on the sapphire substrate, the high-frequency characteristics are enhanced.

### BACKGROUND OF THE INVENTION

The present invention relates to an optical integrated circuit using a circuit configured by an optical waveguide, an opto-electronic integrated circuit with the optical integrated circuit mounted thereto, and a method for manufacturing these.

As a device using an optical waveguide circuit, there is known, for example, an opto-electronic integrated circuit. The opto-electronic integrated circuit is of a circuit in which an optical integrated circuit and a semiconductor integrated circuit are provided on the same substrate.

In the optical integrated circuit, a planar lightwave circuit (PLC) is used in many cases. The planar lightwave circuit is of a circuit which realizes various functions such as light-signal multiplexing and demultiplexing and the like using an optical waveguide formed on a substrate. A configuration of the optical waveguide used in the planar lightwave circuit has been disclosed in, for example, the following non-patent document 1 (“Handbook for Application of Amorphous Silica Materials” edited by katsuro Fukozu, Realize Inc., May 31, 1999, p. 572-p. 574) and patent documents 1 (Japanese Patent Publication Laid Open Number 2001-235640) and 2 (Japanese Patent Publication Laid Open Number Hei 5(1993)-210021).

The optical waveguide shown in FIG. 2 of the non-patent document 1 includes a substrate, a lower clad, a core and an upper clad.

The conventional optical waveguide uses a quartz glass substrate or a silicon substrate as a substrate. a silicon oxide film (whose thickness is 20 μm, for example) used as a lower clad and a silicon oxide film (whose thickness ranges from 5 μm to 8 μm, for example) for each core are formed using, for example, frame hydrolysis deposition, a chemical vapor deposition method or an electron beam deposition method or the like. At this time, one or both of these silicon oxide films are doped with an impurity thereby to set the difference in refractive index between the silicon oxide film for the core and the lower clad to about 0.2 to 5 percents. Here, a difference Δ between the refractive index n1 of the core and the refractive index n2 of the lower clad is given by Δ=(n1−n2)/n1. As an impurity for enhancing the refractive index of the silicon oxide film for the core, for example, germanium (Ge), phosphorus (P), titanium (Ti) or the like is used. On the other hand, for example, fluorine (F), boron B or the like is used as an impurity for reducing the refractive index of the clad formed of silicon oxide. Incidentally, when the quartz glass substrate is used, it may also be used as the lower clad as it is.

Subsequently, a resist film is applied onto the entire surface of the substrate and patterned using a normal photolithography method. Etching such as reactive ion etching is conducted with the resist pattern as a mask thereby to form a core.

Thereafter, a silicon oxide film (whose thickness is 20 μm, for example) used as an upper clad is formed over the entire surface of the substrate. A method for forming the upper clad may be the same as one for the lower clad and the silicon oxide film for the core. In a manner similar to the lower clad, the upper clad is also set in such a manner that a difference Δ in refractive index between the upper clad and the core reaches 0.2 to 0.5 percents.

Thus, the periphery of the core formed by the high refractive-index silicon oxide film is covered with the clad formed of the silicon oxide film lower in refractive index than the core thereby to make it possible to confine propagation light within the core, whereby the propagation of a light signal is enabled.

The patent document 1 has disclosed that sapphire can be used as a substrate (refer to the paragraph 0020 and FIG. 3 in the patent document 1). In the patent document 1, a sapphire substrate is used as a lower clad and a ferroelectric optical monocrystal film used as a core is formed on the lower clad (refer to the paragraph 0021 in the patent document 1).

The patent document 2 has disclosed that a core can be formed using a silicon film (refer to the paragraph 0022 in the patent document 2) and that a silicon film used as a lower clad is formed on its corresponding sapphire substrate in such a case (refer to the paragraph 0025 in the patent document 2).

An opto-electronic integrated circuit is fabricated by providing a semiconductor integrated circuit on the same substrate as the above-described planar lightwave circuit. Here, a hybrid opto-electronic integrated circuit can be fabricated by fixedly securing a semiconductor integrated circuit chip onto the substrate by soldering or the like. A monolithic opto-electronic integrated circuit can be fabricated by forming a silicon film on the substrate thereby to form a semiconductor integrated circuit or forming a semiconductor integrated circuit directly on a silicon substrate.

When, however, the opto-electronic integrated circuit is fabricated using the conventional planar lightwave circuit, the following drawbacks occur.

When the planar lightwave circuit and the semiconductor integrated circuit are formed on the silicon substrate on a hybrid or monolithic basis, such a conventional planar lightwave circuit as mentioned above has the drawback that parasitic capacitance produced in the semiconductor integrated circuit increases. Therefore, the opto-electronic integrated circuit using the silicon substrate is not capable of obtaining sufficient characteristics upon a high-speed operation of 1 Gbyte/second or more. It was therefore difficult to use it in applications such as high-speed optical communications.

While the optical waveguide can be formed even on the glass substrate as described above, the fabrication of the semiconductor integrated circuit for the high-speed optical communications on the glass substrate is difficult for techniques under the present situation due to crystallizability, temperatures and the like. It is therefore very difficult to fabricate the opto-electronic integrated circuit using the glass substrate.

The conventional planar lightwave circuit referred to above has the drawback that it is difficult to sufficiently increase the difference in refractive index between the core and each of the clads (lower clad and upper clad). As described above, the lamination of the core and the clads can be used as the optical waveguide if the difference in refractive index is set to 0.2 to 0.5 percentages. As, however, the refractive-index difference becomes smaller, lightwave emitted into the substrate and the atmosphere through the core increases (i.e., light confinement or locked-in effect is deteriorated). Therefore, when it is not possible to increase the refractive-index difference sufficiently, there is a need to thicken the thickness of each clad to suppress the emission of the lightwave. There is a fear that when the thickness of each clad is made thick, the deposition time and etching time become long and deposition/processing or the like becomes difficult in the process of manufacturing the lower clad and the upper clad, thereby reducing yields. As a result, the manufacturing cost increases. When the core and clads are both formed of silicon oxide as mentioned above, the difference in refractive index is normally merely set to 0.5% or less. As a result, the sum of the thicknesses of the lower clad, core and upper clad reaches a few tens of

### SUMMARY OF THE INVENTION

With the foregoing problems in view, it is an object of the present invention to provide an optical integrated circuit at a low price and provide an opto-electronic integrated circuit excellent in high-frequency characteristic at a low price.

There is provided a first invention that relates to an optical integrated circuit including a circuit configured using an optical waveguide.

The optical waveguide has a sapphire substrate configured as a lower clad, and at least one core configured as a silicon film pattern and formed on the sapphire substrate.

There is provided a method for manufacturing an optical integrated circuit according to a second invention, the method comprising forming a resist pattern that covers a predetermined region lying on a silicon-on-sapphire substrate, and etching a silicon film of the silicon-on-sapphire substrate with the resist pattern as a mask thereby to form a core in the predetermined region. There is provided an opto-electronic integrated circuit according to a third invention, comprising an optical integrated circuit having an optical waveguide using a sapphire substrate as a lower clad and a silicon film lying on the sapphire substrate as a core, and an electronic integrated circuit provided in an area over the sapphire substrate, which is unformed with the optical integrated circuit.

There is provided a method for manufacturing an opto-electronic integrated circuit according to a fourth invention, the method comprising forming an electronic integrated circuit in a silicon film lying on a sapphire substrate, forming a resist pattern that covers the electronic integrated circuit and a region to form a core of an optical waveguide, and etching the silicon film with the resist pattern as a mask thereby to form the core.

According to the first and second inventions, since the sapphire substrate is used as the lower clad of the optical waveguide and silicon is used as the core of the optical waveguide, a sufficient difference in refractive index can be obtained. Therefore, the size of the core can be reduced. Thus, since the number of processes for fabricating the core and the time required to fabricate the core can be cut down, and yields can be improved, an optical integrated circuit can be provided at low cost. According to the third and fourth inventions, since the core and the electronic integrated circuit are formed in the silicon film lying on the same sapphire substrate, the optical integrated circuit in which the sapphire substrate is used as the lower clad of the optical waveguide and silicon is used as the core of the optical waveguide, and the electronic integrated circuit of the SOS (Silicon On Sapphire) substrate type can be provided on the same sapphire substrate. It is thus possible to provide an opto-electronic integrated circuit excellent in high-frequency characteristic at a low price.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a sectional view conceptually showing an optical waveguide structure of an optical integrated circuit according to a first preferred embodiment;

FIG. 2 is a sectional process view for describing a method for manufacturing an optical waveguide according to the first preferred embodiment;

FIG. 3 is a sectional view conceptually showing a modification of the optical waveguide according to the first preferred embodiment;

FIG. 4 is a sectional view conceptually illustrating a modification of the optical waveguide according to the first preferred embodiment;

FIG. 5 is a sectional view conceptually depicting a modification of the optical waveguide according to the first preferred embodiment;

FIG. 6 is a conceptual view showing a structure of an opto-electronic integrated circuit according to a second preferred embodiment;

FIG. 7 is a view for describing high-frequency characteristics of an electronic integrated circuit provided in the opto-electronic integrated circuit according to the second preferred embodiment, wherein FIG. 7A is a conceptual view showing a simulation model, FIG. 7B is a graph showing high-frequency characteristics of the embodiment, and FIG. 7C is a graph showing high-frequency characteristics of a conventional example;

FIG. 8 is a sectional process view for describing a method for manufacturing the opto-electronic integrated circuit according to the second preferred embodiment;

FIG. 9 is a sectional process view for describing the method for manufacturing the opto-electronic integrated circuit according to the second preferred embodiment;

FIG. 10 is a sectional process view for describing the method for manufacturing the opto-electronic integrated circuit according to the second preferred embodiment;

FIG. 11 is a sectional process view for describing the method for manufacturing the opto-electronic integrated circuit according to the second preferred embodiment;

FIGS. 12A and 12B are respectively conceptual views showing a configuration of a photodiode array according to the second preferred embodiment and FIG. 12C is a conceptual view for describing a method for manufacturing an opto-electronic integrated circuit according to the second preferred embodiment; and

FIG. 13A is a conceptual view showing a configuration of a laser diode array according to the second preferred embodiment, and FIG. 13B is a conceptual view for describing a method for manufacturing an opto-electronic integrated circuit according to the second preferred embodiment.

### DETAILED DESCRIPTION OF THE PREFERRED EMBODIMENTS

Preferred embodiments of the present invention will hereinafter be described using the accompanying drawings. Incidentally, the size, shape and physical relationship of each constituent element in the accompanying drawings are merely approximate illustrations to enable an understanding of the present invention, and further numerical conditions explained below are nothing more than mere examples.

### First Preferred Embodiment

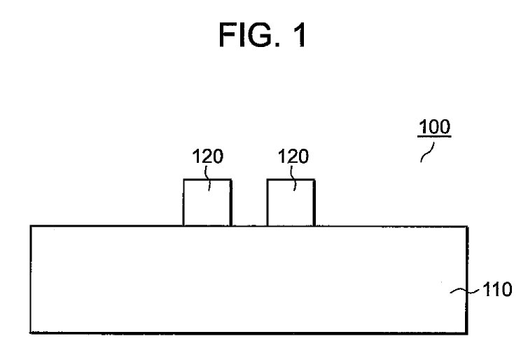

A preferred embodiment of an optical integrated circuit according to the present invention will be explained using FIGS. 1 through 5.

FIG. 1 is a sectional view conceptually showing an optical waveguide structure of the optical integrated circuit according to the present embodiment.

As shown in FIG. 1, an optical waveguide 100 according to the present embodiment includes a lower clad 110 and cores 120.

The lower clad 110 is configured by a sapphire substrate. Here, a refractive index of sapphire is 1.75 in the case of light having a light wavelength of 1550 nm. The thickness of the sapphire substrate ranges from 330 μm to 460 μm, for example.

Each of the cores 120 is comprised of a silicon film formed directly on the lower clad 110. Here, a refractive index of silicon is 3.48 in the case of a light wavelength of 1550 nm. A sectional shape of each core is rectangular and its dimensions, e.g., the thickness thereof is about 0.22 μm and the width thereof is about 0.22 μm.

As will be described later, the optical waveguide 100 according to the present embodiment can be fabricated using an SOS (Silicon On Sapphire) substrate.

The optical waveguide 100 according to the present embodiment is configured so as to become a single mode or unimodal waveguide in high-speed optical communications (wavelength: 1550 nm). A single-mode condition of the optical waveguide is given by the following equation (1):

V=π(2a/λ)·n1·√ (2Δ)<2/π (1)

In the equation (1), V indicates a normalized frequency. λ indicates a light wavelength and is 1550 nm in the case of high-speed optical communications. a indicates a value equal to half the core width. Δ indicates a difference in refractive index (described above). In the present embodiment, the refractive index n1 of the core is 3.48. The refractive index n2 of the clad is 1.75 in the case of the lower clad (sapphire) of the sapphire and 1 because an upper clad is of the atmosphere. Thus, an optical waveguide width (i.e., core width 2a) that satisfies the single-mode condition is less than about 0.22 μm with respect to the lower clad and less than 0.19 μm with respect to the upper clad. As a result, if the core width 2a<0.22 μm, then single-mode light can be obtained.

In order to propagate a light signal with being confined within the cores 120, there is a need to satisfy the following equation (2):

β≧n2·k0 (2)

In the equation (2), β indicates a propagation constant, n2 indicates a clad's refractive index, and k0 indicates a wave number (i.e., 2π/λ). It is understood from the equation (2) that it is desirable to increase the core width for the purpose of enhancing a confinement or locked-in effect thereby to reduce a loss of signal light, i.e., to reduce the radiation or emission of light to the outside of the optical waveguide. Therefore, the maximum width of the dimensions at which the single-mode light is obtained, is normally adopted as the core width 2a.

For this reason, the sectional size of the core 120 was set to about 0.22 μm×about 0.22 μm in the present embodiment. That is, the thickness of the optical waveguide formed on the sapphire substrate 110 is about 0.22 μm.

On the other hand, in the conventional optical waveguide, i.e., the optical waveguide in which the cores and clad are both formed of silicon oxide, the core width 2a at λ=1550 nm becomes less than 7 μm from the above equation (1) assuming that the refractive-index difference Δ is 0.3. The minimum value of the core width 2a for satisfying the above equation (2) is about 4.8 μm. Further, since the refractive-index difference Δ is small in the conventional optical waveguide, the locked-in effect is not sufficient even if the core width is set to 7 μm, and correspondingly the clad needs to be formed thick. According to the discussions of the present inventors, both the lower and upper clads need to have a clad thickness of 20 μm or more in the conventional optical waveguide. As a result, the full film thickness of the conventional optical waveguide becomes 47 μm or more. When the lower clad is made unnecessary by using a silicon substrate in the conventional optical waveguide, the full film thickness becomes 27 μm.

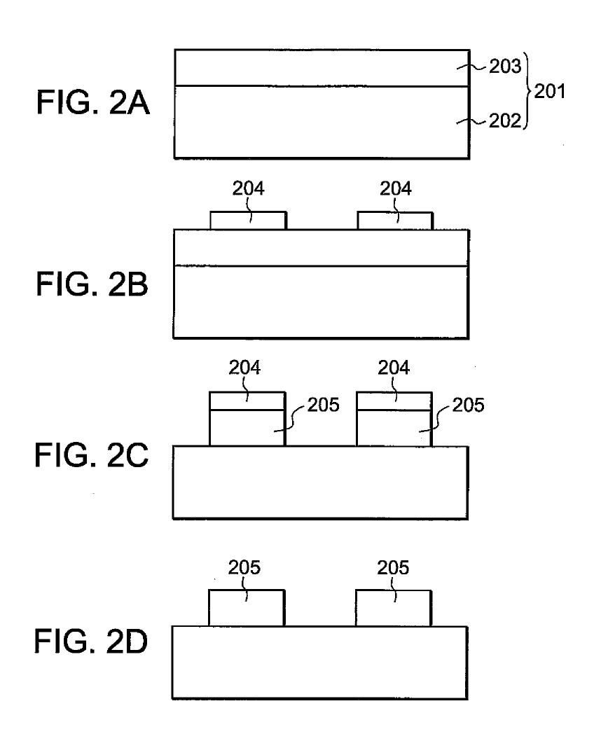

According to the present embodiment as is understood from the above description, the full film thickness of the optical waveguide can be made very small as compared with the conventional case. Thus, according to the present embodiment, the time required to perform each of deposition and etching upon the manufacture of the optical waveguide can be shortened, and the yields of such deposition/processing or the like can be enhanced, thus making it possible to reduce its manufacturing cost. FIGS. 2A through 2D are a sectional process view for describing a method for manufacturing the optical waveguide 100 according to the present embodiment. As described above, the optical waveguide 100 according to the present embodiment can be manufactured using an SOS substrate 201 (refer to FIG. 2A). In the SOS substrate 201 as is well known, a silicon film 203 (0.24 μm in the present embodiment) is formed on the surface of a sapphire substrate 202 (whose thickness ranges from 330 μm to 460 μm, for example).

First, the SOS substrate 201 is cleaned. After washing the SOS substrate 201 with a mixed solution of H₂SO₄/H₂O₂ at 85° C. for five minutes, for example, it is washed with pure water for five minutes. Further, the SOS substrate 201 may be washed with pure water for five minutes after washing it with a 0.5% fluorine oxidation solution for 20 seconds.

Next, a resist having a film thickness of 1 μm is applied onto the surface of the SOS substrate 201. This resist film is exposed through a mask corresponding to an optical waveguide pattern using, for example, an ultraviolet exposure device. After development processing, it is heated for 30 minutes at 120° C. Thus, each resist pattern 204 corresponding to the optical waveguide pattern can be obtained (refer to FIG. 2B).

Subsequently, the silicon film 203 is patterned using, for example, a reactive ion etching method with the resist patterns 204 as masks. Thus, cores 205 can be formed (refer to FIG. 2C).

Thereafter, the resist patterns 204 are peeled off using oxygen plasma or the like and the formation of the optical waveguide 100 is completed (refer to FIG. 2D).

Incidentally, although it has been described in FIGS. 1 and 2 that the configuration of the optical waveguide 100 by the lower clad 110 and the rectangular cores 120 alone is taken as an example, it is needless to say that the present invention can be applied even to an optical waveguide having another structure.

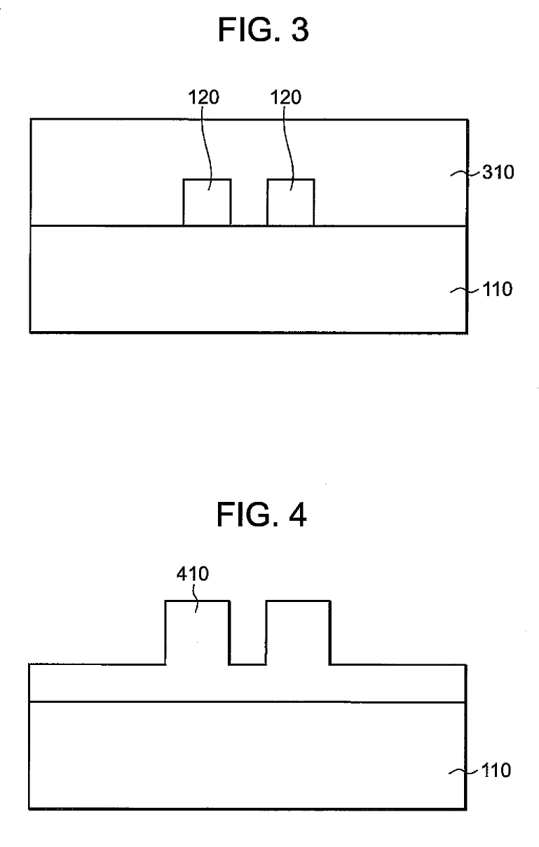

FIG. 3 is a sectional view conceptually showing an example in which the present embodiment is applied to an optical waveguide having an upper clad. In the example shown in FIG. 3, a sapphire substrate used as a lower clad 110, and cores 120 formed of silicon are covered with the upper clad 310 formed of silicon oxide. Incidentally, a material for forming the upper clad 310 may be a material lower in refractive index than silicon that forms the cores 120. For example, silicon nitride, a polymeric material and the like can also be used.

FIG. 4 is a conceptual sectional view showing an example in which a core is configured as a rib type. In the example of FIG. 4, a rib-type core 410 is formed on a sapphire substrate used as a lower clad 110. The rib-type core 410 can be formed by leaving behind silicon having a predetermined thickness upon core's patterning (refer to FIG. 2C). As sectional dimensions of the rib-type core 410, for example, the thickness of the left portion is 2 μm, and the patterned portion is 3 μm wide and 2 μm long.

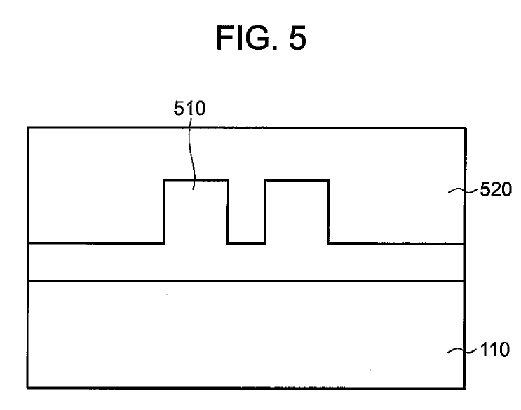

FIG. 5 is a conceptual sectional view showing an example in which a rib-type core is adopted and an upper clad is provided. In the example of FIG. 5, a rib-type core 510 formed of silicon is formed on a sapphire substrate used as a lower clad 110. Further, an upper clad 520 is formed on the rib-type core 510. Sectional dimensions of the rib-type core 510 and a material for forming the upper clad 520 may be the same as the cases shown in FIGS. 3 and 4.

According to the present embodiment as described above, since the sapphire substrate is configured as the lower clad 110 and the silicon film is configured as the cores 120, the silicon film can be made thin. It is thus possible to enhance the yields of the deposition/processing time at the manufacture of the optical integrated circuit. Thus, according to the present embodiment, the manufacturing cost of the optical integrated circuit can be reduced.

The process of forming the lower clad layer becomes unnecessary. Even in this point, the manufacturing cost of the optical integrated circuit can be reduced.

### Second Preferred Embodiment

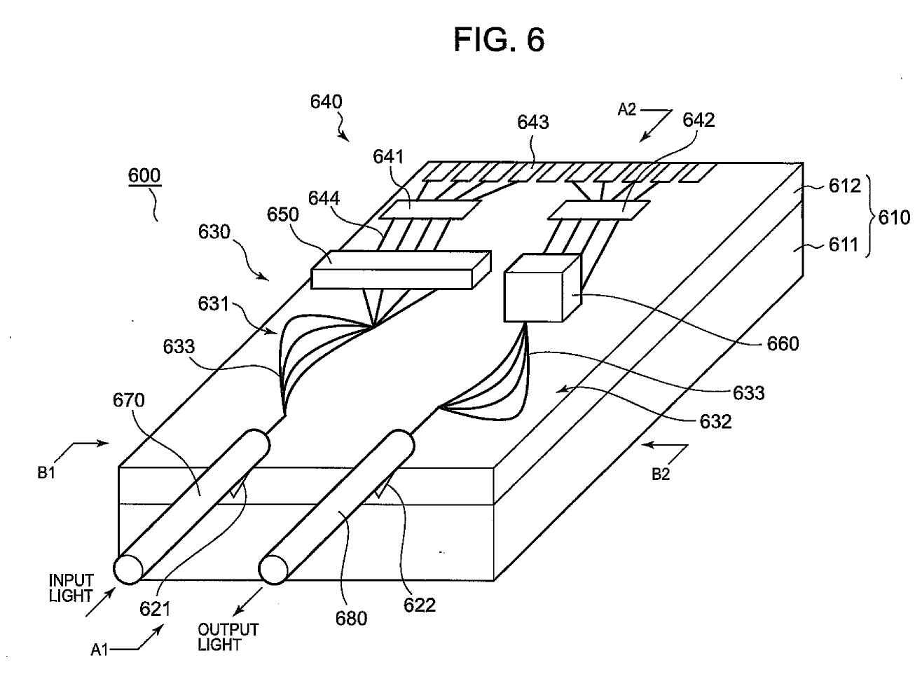

A second preferred embodiment of an opto-electronic integrated circuit according to the present invention will be explained using FIGS. 6 through 13.

FIG. 6 is a conceptual view showing an overall configuration of the opto-electronic integrated circuit according to the present embodiment.

As shown in FIG. 6, the opto-electronic integrated circuit 600 according to the present embodiment includes an SOS substrate 610, an optical integrated circuit 630, an electronic integrated circuit 640, a photodiode array 650 and a laser diode array 660. The opto-electronic integrated circuit 600 is connected to an input optical fiber 670 and an output optical fiber 680.

The SOS substrate 610 has a sapphire substrate 611 and a silicon film 612. The sapphire substrate 611 is used as a substrate for forming the electronic integrated circuit 640 and also used as a lower clad of each optical waveguide that constitutes the optical integrated circuit 630 in a manner similar to the first preferred embodiment (refer to FIG. 1). A refractive index of sapphire is 1.75 in the case of a light wavelength of 1550 nm. The thickness of the sapphire substrate ranges from 330 μm to 460 μm, for example. The silicon film 612 is used to form each core of the optical waveguide and used to form a semiconductor element such as a transistor. A refractive index of silicon is 3.48 with respect to light having a wavelength of 1550 nm. In the present embodiment, the thickness of the silicon film 612 is assumed to be about 0.22 μm. The SOS substrate 610 is provided with grooves 621 and 622. The grooves 621 and 622 are used to fix the optical fibers 670 and 680.

The optical integrated circuit 630 has a demultiplexing circuit 631 for an input light signal and a multiplexing circuit 632 for an output signal. The demultiplexing circuit 631 and the multiplexing circuit 632 are respectively configured using optical waveguides 633. The demultiplexing circuit 631 demultiplexes a light signal inputted from the optical fiber 670 according to wavelengths λ1, λ2, λ3 and λ4 (where λ1≠λ2≠λ3≠λ4) and sends the result of demultiplexing to the photodiode array 650. The multiplexing circuit 632 multiplexes four-system light signals (wavelengths: λ1, λ2, λ3 and λ4) inputted from the laser diode array 660 and sends the result of multiplexing to the optical fiber 680. Since the structure and principle of each of the demultiplexing circuit 631 and the multiplexing circuit 632 are known, their explanations will be omitted. In the present embodiment as described above, each optical waveguide 633 is configured by the lower clad made of sapphire and the cores made of silicon in a manner similar to the first preferred embodiment (refer to FIG. 1).

The electronic integrated circuit 640 has a transimpedance amplifier circuit 641, a driver circuit 642, electrode pads 643 and wirings 644. The transimpedance amplifier circuit 641 amplifies an electric signal outputted from the photodiode array 650 and outputs it to its corresponding electrode pad 643. The driver circuit 642 drives the laser diode array 660 according to the electric signal inputted from the corresponding electrode pad 643. The transimpedance amplifier circuit 641 and the driver circuit 642 are respectively configured of transistors and the like formed in the silicon film 612. Since the concrete structure and principle of each of the transimpedance amplifier circuit 641 and the driver circuit 642 are known, their explanations will be omitted.

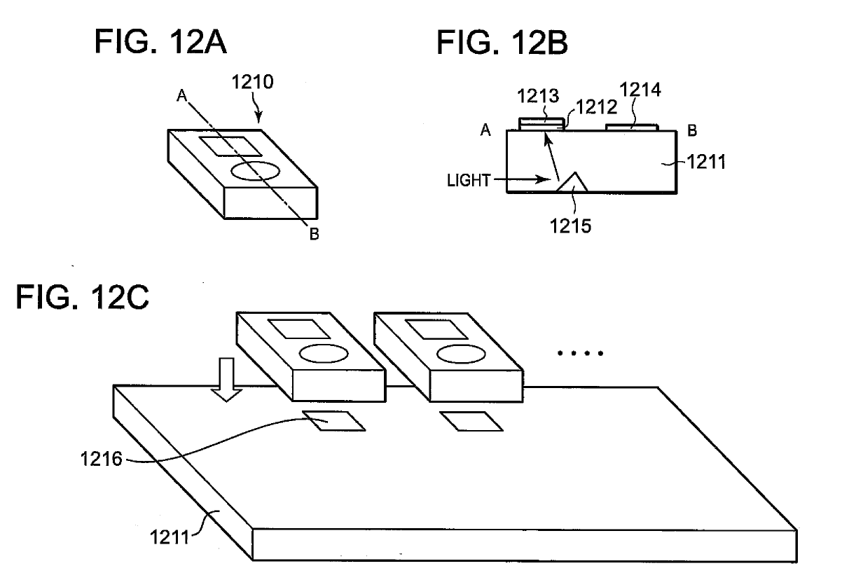

The photodiode array 650 converts light signals (wavelengths: λ1, λ2, λ3 and λ4) demultiplexed by the demultiplexing circuit 631 to their corresponding electric signals. The photodiode array 650 is configured by four photodiode elements 1210 (refer to FIGS. 12A and 12B). Each of the photodiode elements 1210 includes an InP substrate 1211, a light-receiving layer 1212, an anode 1213, a cathode 1214 and a mirror 1215. The light-receiving layer 1212 is formed of InGaAs or the like. The mirror 1215 is shaped in the form of a V-shaped groove formed by anisotropic etching and reflects incident light to lead to the light-receiving layer 1212. As a result, current corresponding to the intensity of the launched signal light flows between the anode and the cathode. As will be described later, the photodiode element 1210 is fixed to its corresponding electrode of the silicon film 612 by solder.

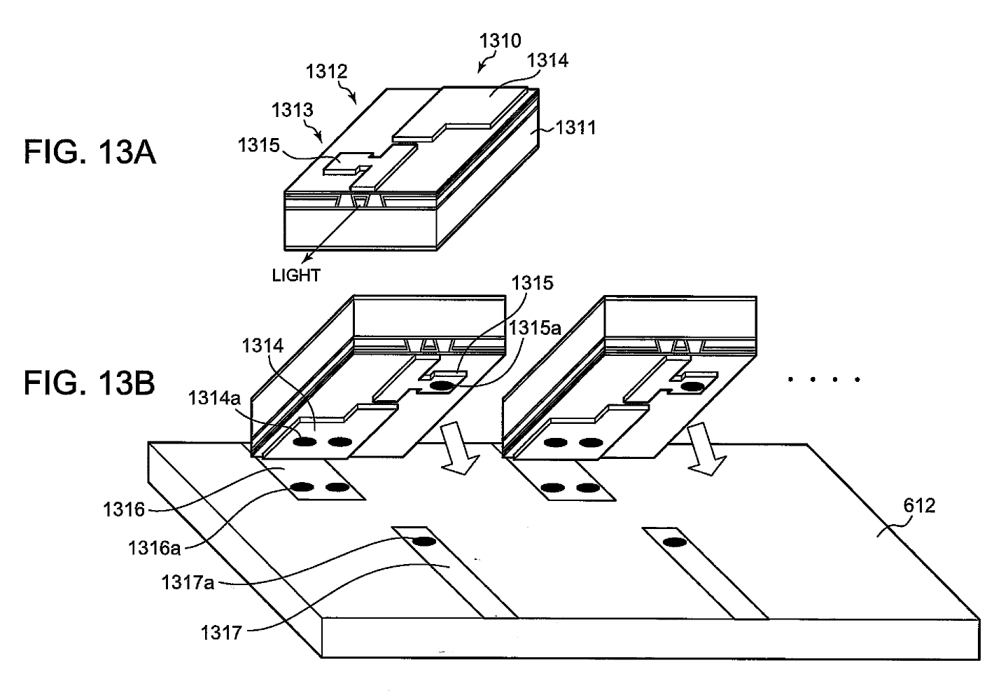

The laser diode array 660 generates and outputs light signals (wavelengths: λ1, λ2, λ3 and λ4) respectively, based on the electric signals inputted from the driver circuit 642. The laser diode array 660 is configured by four laser diode elements 1310 (refer to FIG. 13A). Each of the laser diode elements 1310 includes an InP substrate 1311, a laser 1312 and a field modulator 1313. The laser 1312 and the field modulator 1313 are provided with an electrode 1314 and an electrode 1315 respectively. The laser 1312 generates and outputs signal light, based on a drive signal inputted from the driver circuit 642 via the electrode 1314. The field modulator 1313 modulates the signal light using an electric field. As a result, the wavelength of the signal light results in a pre-set value (any of λ1, λ2, λ3 and λ4). As will be described later, each laser diode element 1310 is fixed to electrode pads 1316 and 1317 lying on the silicon film 612 by solder.

The input optical fiber 670 is fixed to the groove 621 and supplies a light signal to the demultiplexing circuit 631. The output optical fiber 680 is fixed to the groove 622 and receives a light signal from the multiplexing circuit 632. Known ones can be used as the optical fibers 670 and 680.

In the opto-electronic integrated circuit 600 of such a configuration, the light signal inputted from the input optical fiber 670 is demultiplexed to four-system light signals (wavelengths: λ1, λ2, λ3 and λ4) by the demultiplexing circuit 631, followed by being converted to their corresponding electric signals by the photodiode array 650 every signal. After they have been amplified by the transimpedance amplifier circuit 641, the so-processed light signals are outputted from their corresponding electrode pads 643. When the electric signals inputted from the input electrode pads 643 are inputted to the driver circuit 642, four-system light signals (wavelengths: λ1, λ2, λ3 and λ4) are outputted from the laser diode array 660 in response to the electric signals and multiplexed by the multiplexing circuit 632, followed by being outputted to the output optical fiber 680.

In the opto-electronic integrated circuit 600 according to the present embodiment in this way, the optical integrated circuit 630 is formed on the sapphire substrate 611. Thus, since the full film thickness of the optical waveguide can be made very small as compared with the conventional case, it is possible to shorten the time required to perform each of deposition and etching at the manufacture of the optical waveguide and enhance the yields of such deposition/processing or the like. As a result, according to the present embodiment, the manufacturing cost of the opto-electronic integrated circuit can be reduced.

Further, according to the present embodiment, since the electronic integrated circuit 640 is formed on the sapphire substrate 611, high-frequency characteristics of the electronic integrated circuit can be improved.

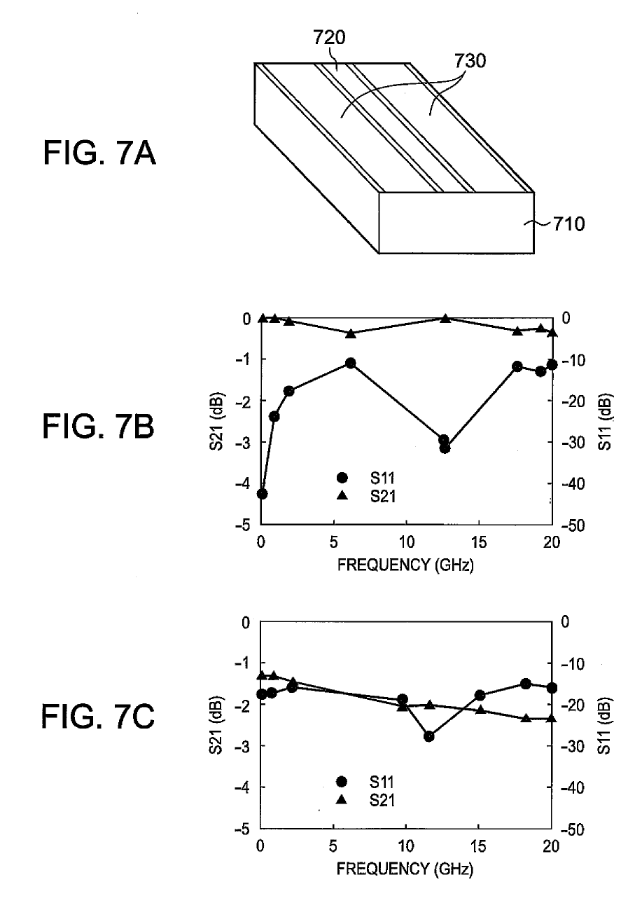

FIGS. 7A through 7C are a view for describing the high-frequency characteristics of the electronic integrated circuit 640 according to the present embodiment, wherein FIG. 7A is a conceptual view showing a simulation model, FIG. 7B is a graph showing high-frequency characteristics of this embodiment, and FIG. 7Cis a graph showing high-frequency characteristics of a conventional example (optical waveguide in which the cores and clad are formed of silicon).

Here, high-frequency characteristics where a signal line 720 and ground lines 730 made of aluminium are formed on a substrate 710 as shown in FIG. 7A were determined by simulation. Here, the substrate 710 is a sapphire substrate in the present embodiment and a silicon substrate in the conventional example. The resistivity of the sapphire substrate is 1016 cm·Ω at 25° C. The resistivity of the silicon substrate was set to 100 cm·Ω at 25° C. due to impurity introduction. In the signal line 720, the width thereof was set to 80 μm and the length thereof was set to 5 mm. The ground lines 730 were formed on both sides of the signal line 720. Spacing defined between the signal line 720 and each of the ground lines 730 is 50 μm.

In FIGS. 7B and 7C, the horizontal axis indicates the frequency [GHz] and the vertical axis indicates the intensity of light [dB]. Each curve S11 indicates S11 of an S parameter and is equivalent to the amount of reflection of a light signal. Each curve S21 indicates S21 of an S parameter and is equivalent to the amount of a loss of a light signal.

As is understood from a comparison in FIGS. 7B and 7C, the signal loss (S21) is caused by about −2 dB in the conventional example (refer to FIG. 7C) and is approximately 0 dB in the present embodiment (refer to FIG. 7B). No noticeable difference appears in the signal reflection (S11).

Thus, according to the present embodiment, satisfactory high-frequency characteristics can be obtained while the signal loss is being suppressed.

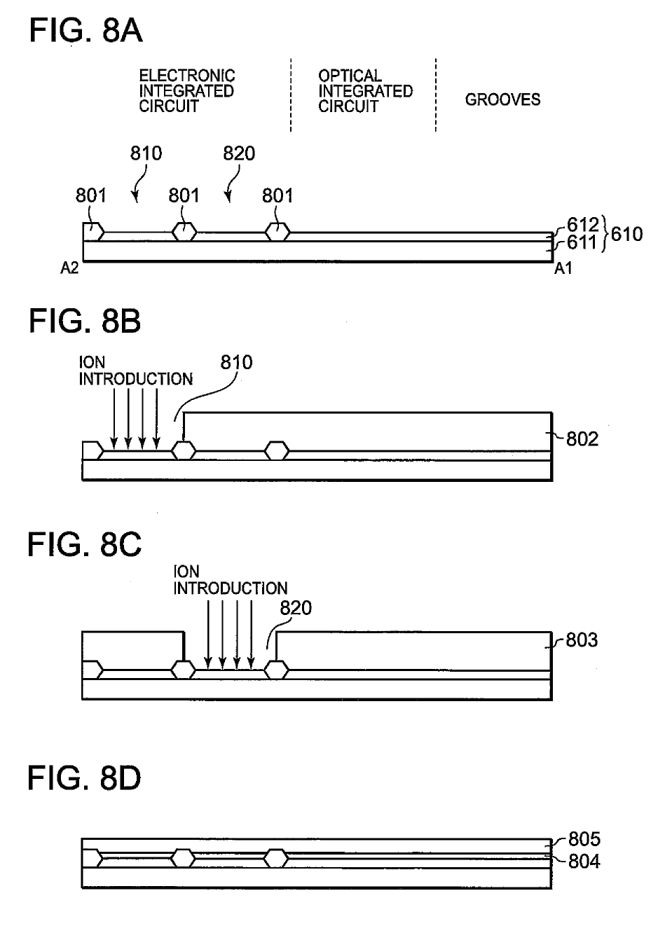

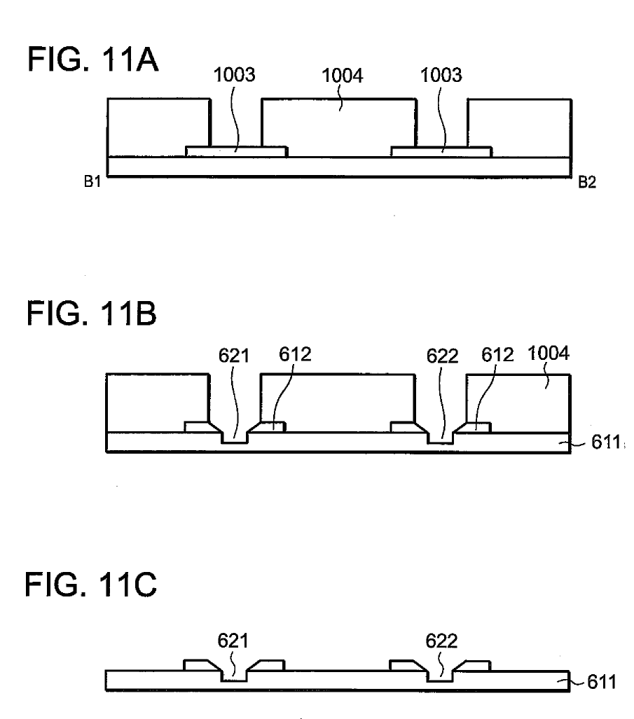

FIGS. 8 through 11 are respectively sectional process views for describing a method for manufacturing the opto-electronic integrated circuit 600 according to the present embodiment. Incidentally, FIGS. 8 through 10 correspond to a section taken along line A1-A2 of FIG. 6, and FIG. 11 corresponds to a section taken along line B1-B2 of FIG. 6.

As described above, the opto-electronic integrated circuit 600 according to the present embodiment can be manufactured using the SOS substrate 610. In the SOS substrate 610 as well known, the silicon film 612 (0.24 μm in the present embodiment) is formed on the surface of the sapphire substrate 611 (whose thickness ranges from 330 μm to 460 μm, for example).

First, the SOS substrate 610 is cleaned. After washing the SOS substrate 610 with a mixed solution of H₂SO₄/H₂O₂ at 85° C. for five minutes, for example, it is washed with pure water for five minutes. Further, the SOS substrate 610 may be washed with pure water for five minutes after washing it with a 0.5% fluorine oxidation solution for 20 seconds.

A silicon nitride film is deposited on the silicon film 612 using, for example, a chemical vapor deposition method. Further, a resist is applied onto the silicon nitride film. The resist film is selectively exposed and developed thereby to form a resist film pattern that covers other than each element isolation region. With the resist film pattern as a mask, for example, reactive ion etching is conducted, thereby forming a silicon nitride film pattern that covers other than each element isolation position. Subsequently, a silicon oxide film is formed in a region or area (i.e., element isolation position) uncovered with the silicon nitride film pattern by using a thermal oxidation method or the like. Thereafter, the silicon nitride film pattern is removed thereby to obtain an element isolation film 801 generally called “LOCOS (localized oxidation of silicon)” (refer to FIG. 8A). An electronic integrated circuit forming area or region of the SOS substrate 610 is divided into an n-type MOSFET (Metal Oxide Semiconductor Field Effect Transistor) forming region 810 and a p-type MOSFET forming region 820 by the element isolation film 801.

Subsequently, a resist film pattern 802 that exposes the region 810 is formed by a process similar to the above-described resist film pattern. Impurity introduction for adjusting a threshold voltage of the n-type MOSFET is performed by ion implantation or the like with the resist film pattern 802 as a mask (refer to FIG. 8B). Thereafter, the resist film pattern 802 is eliminated.

Further, a resist film pattern 803 that exposes the region 820 is formed by a process similar to the resist film pattern. Impurity introduction for adjusting a threshold voltage of the p-type MOSFET is performed by ion implantation or the like with the resist film pattern 803 as a mask (refer to FIG. 8C). Thereafter, the resist film pattern 803 is eliminated.

Next, a silicon oxide film 804 to be a gate oxide film is formed on the SOS substrate 610 by using the thermal oxidation method or the like, for example. A polysilicon film 805 configured as a gate electrode is formed on the silicon oxide film 804 using the chemical vapor deposition method or the like, for example (refer to FIG. 8D). Incidentally, a silicide film may further be formed on the polysilicon film 805.

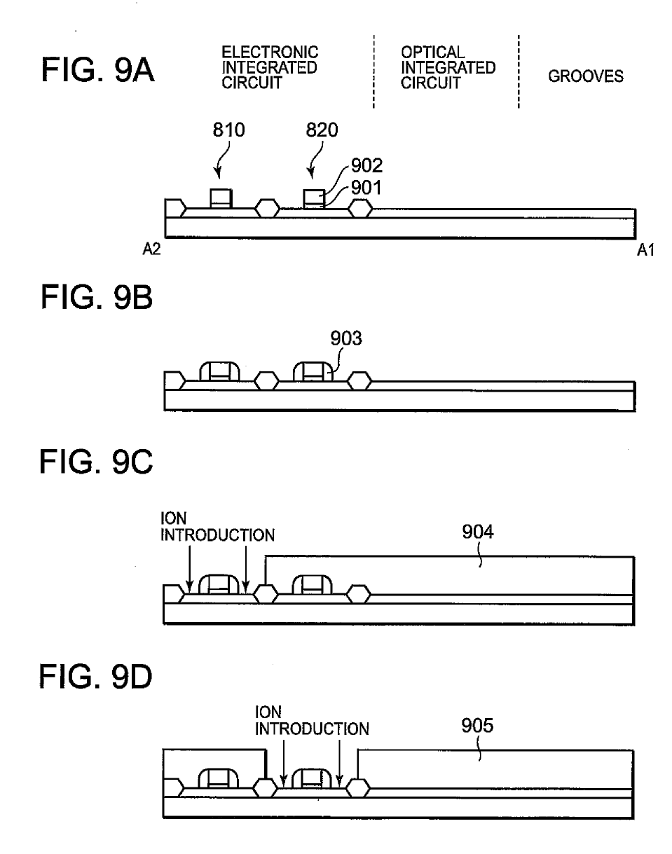

Subsequently, a resist film pattern that covers the polysilicon film 805 is formed. A gate oxide film 901 and a gate electrode 902 are formed in each of the regions 810 and 820 by reactive ion etching or the like with the resist film pattern as a mask (refer to FIG. 9A).

After silicon nitride has been deposited using the chemical vapor deposition method or the like, the silicon nitride is processed using the reactive ion etching method or the like, thereby forming sidewalls 903 on their corresponding side faces of each of the gate oxide film 901 and the gate electrode 902 (refer to FIG. 9B).

Subsequently, a resist film pattern 904 that exposes the region 810 is formed. A source/drain region of the n-type MOSFET is formed by ion implantation or the like with the resist film pattern 904 as a mask (refer to FIG. 9C).

Further, a resist film pattern 905 that exposes the region 820 is formed. A source/drain region of the p-type MOSFET is formed by ion implantation or the like with the resist film pattern 905 as a mask (refer to FIG. 9D).

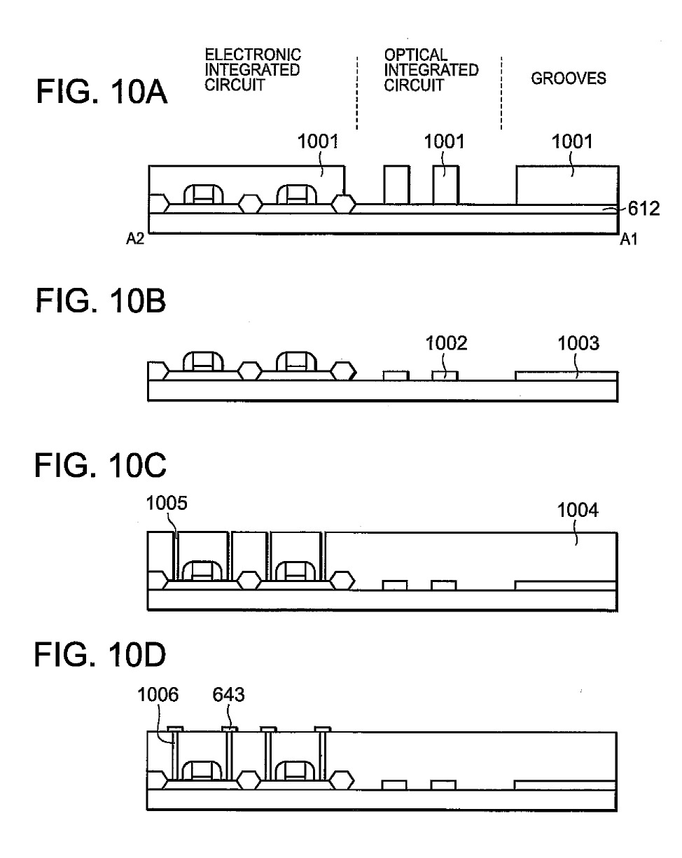

Next, a resist film pattern 1001 is formed in a manner similar to the above-described respective resist film patterns (refer to FIG. 10A). The resist film pattern 1001 is formed so as to cover the regions or areas for forming the electronic integrated circuit 640, the optical waveguide 633 and the grooves 621 and 622.

The silicon film 612 is processed by reactive ion etching or the like with the resist film pattern 1001 as a mask. Thereafter, the resist film pattern 1001 is eliminated, thereby obtaining cores 1002 and a groove forming region or area 1003 for each optical waveguide 633 (refer to FIG. 10B).

Subsequently, a silicon oxide film 1004 for a passivation film is formed over the entire surface of the SOS substrate 610 using the chemical vapor deposition method or the like, for example. Incidentally, a silicon nitride film may be further formed on the silicon oxide film 1004. Afterwards, a resist film pattern that exposes only each contact hole forming region of the electronic integrated circuit 640 is formed. Reactive ion etching or the like with the resist film pattern as a mask is conducted, thereby forming contact holes 1005. The resist film pattern is removed (refer to FIG. 10C).

Next, aluminum is deposited using the chemical vapor deposition method or the like, for example, thereby forming contacts 1006 within the contact holes 1005. Further, aluminium is deposited on the silicon oxide film 1004 by the chemical vapor deposition method or the like, for example, followed by be patterned by reactive ion etching or the like with the resist film pattern as a mask, thereby forming electrode pads 643 and wirings 644 (refer to FIG. 10D and FIG. 6). Incidentally, at this time, electrode pads (not shown) for connecting/fixing the photodiode array 650 and the laser diode array 660 to the electronic integrated circuit 640 are also formed.

Subsequently, part of each groove forming region 1003 is exposed from the silicon oxide film 1004 using the reactive ion etching or the like with the resist film pattern as the mask (refer to FIG. 11A).

The silicon film 612 is anisotropically etched by wet etching or the like using a sodium hydroxide solution, for example. Further, the central part of each etched portion is diced to form the grooves 621 and 622 in the sapphire substrate 611 (refer to FIG. 11B). Incidentally, the grooves 621 and 622 may also be formed by reactive ion etching as an alternative to the dicing method.

Thereafter, the silicon oxide film 1004 for the region in which the optical integrated circuit 630 and the grooves 621 and 622 are formed, is eliminated using the reactive ion etching or the like with the resist film pattern as the mask (refer to FIG. 11C).

The optical integrated circuit 630 and the electronic integrated circuit 640 can be monolithically mounted on the SOS substrate 610 in the above-described manner. Next, solder bumps 1314a and 1315a are formed in the electrodes 1314 and 1315 of each laser diode element 1310. Further, solder bumps 1316a and 1317a are formed in the electrodes 1316 and 1317 on the silicon film 612 side (refer to FIG. 13B). As a solder material, for example, AnSn can be used.

Thereafter, the electrodes 1314 and 1316 and the electrodes 1315 and 1317 are respectively brought into contact with one another, and these electrodes are heated to 280° C. Thus, the solder bumps 1314a, 1315a, 1316a and 1317a are melted and bonded to one another. The laser diode array 660 is mounted onto the SOS substrate 610 on a hybrid basis in this way.

Likewise, the substrate of each photodiode element 1210 is fixed to the electrode 1216 of the silicon film 612, and the anode 1213 and cathode 1214 are wired (refer to FIG. 12C). Thus, the photodiode array 650 is mounted onto the SOS substrate 610 on a hybrid basis.

Incidentally, in the present embodiment, the cores 1002 of the optical integrated circuit 630 and the MOSFETs of the electronic integrated circuit 640 are formed by the silicon film 612 provided in advance on the SOS substrate 610 (refer to FIGS. 9 and 10). Namely, the silicon thickness of each core 1002 and the silicon thickness of each MOSFET of the electronic integrated circuit 640 are identical to each other. However, the core 1002 and the MOSFET can also be formed of discrete silicon films respectively. Upon forming each core 1002, for example, a new silicon film may be formed after the removal of the silicon film 612 in the optical integrated circuit forming area. Thus, since the height of each core 1002 and the depth of a source/drain region of each MOSFET can be set individually, it is possible to reduce design restraints and attain an improvement in the performance of the opto-electronic integrated circuit and the like.

When an impurity is introduced into the cores 1002 to adjust a refractive index, the process of introducing the impurity can also be shared for the impurity introducing process (FIGS. 8B and 8C) for adjusting the threshold values of the n-type MOSFET forming region 810 and the p-type MOSFET forming region 820 or the process of impurity introduction into the source/drain region (refer to FIGS. 9C and 9D). Since, however, the non-sharing of these impurity introducing processes enables the individual settings of impurity concentrations, it is advantageous in reducing design restraints and attaining an improvement in the performance of the opto-electronic integrated circuit and the like.

Further, although the electronic integrated circuit 640 is monolithically formed in the present embodiment, it may be mounted on the SOS substrate 610 on a hybrid basis. In this case, an electronic integrated circuit chip can be joined and fixed to the SOS substrate 610 using solder, for example.

According to the present embodiment as described above, since the optical waveguide is formed using the sapphire substrate and the silicon film, and the electronic integrated circuit is provided on the sapphire substrate, an opto-electronic integrated circuit equipped with an optical waveguide excellent in high-frequency characteristic can be provided at a low price.

While the preferred forms of the present invention have been described, it is to be understood that modifications will be apparent to those skilled in the art without departing from the spirit of the invention. The scope of the invention is to be determined solely by the following claims.

What is claimed is:

1. An optical integrated circuit comprising:
a circuit configured using an optical waveguide,
wherein the optical waveguide includes a sapphire substrate configured as a lower clad, and
at least one core configured as a silicon film pattern and formed on the sapphire substrate.

2. The optical integrated circuit according to claim 1, wherein the optical waveguide further includes an upper clad formed of a silicon oxide film that covers the core.

3. The optical integrated circuit according to claim 1, wherein the core is shaped in rib form.

4. An opto-electronic integrated circuit comprising:
an optical integrated circuit having an optical waveguide using a sapphire substrate as a lower clad and a silicon film lying on the sapphire substrate as a core; and
an electronic integrated circuit provided in an area over the sapphire substrate, which is unformed with the optical integrated circuit.

5. The opto-electronic integrated circuit according to claim 4, wherein the electronic integrated circuit comprises at least one MOSFET, and
wherein the silicon film of the core and the silicon film of the MOSFET are identical.

6. The opto-electronic integrated circuit according to claim 5, wherein the electronic integrated circuit is mounted on a hybrid basis by fixing a pre-fabricated semiconductor integrated circuit chip onto the sapphire substrate.

7. The opto-electronic integrated circuit according to claim 4, further including first and second optical integrated circuit blocks provided within the optical integrated circuit,
a first groove for fixing a first optical fiber outputting a light signal to the first optical integrated circuit block,
a second groove for fixing a second optical fiber inputting a light signal from the second optical integrated circuit block,
a first converter for converting the light signal inputted from the first optical integrated circuit block into an electric signal and outputting the same to the electronic integrated circuit, and
a second converter for converting the electric signal inputted from the electronic integrated circuit into a light signal and outputting the same to the second optical integrated circuit block.
